(19) United States
(12) Patent Application Publication
(10) Pub. No.: US 2008/0085102 A1
(43) Pub. Date: Apr. 10, 2008

(54) Interactive learning system

(76) Inventors: Michael Alm, Woodstock, IL (US); Michael Blaustein, Chicago, IL (US); Ng Kwok-ho Victor, Hong Kong (HK); Barbara Plain, Winnetka, IL (US); Richard M. Woldenberg, Highland Park, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/544,844

(22) Filed: Oct. 5, 2006

(51) Int. Cl. H04N 5/00

(52) U.S. Cl. 386/125

(57) ABSTRACT

An interactive learning system provides activities that combine the use of printed or other visual materials and audio prompts and user response. The system includes removable media such as cards and other devices, content media such as compact discs and other devices, and an interactive device that interacts with both the removable and content media. A user can insert both types of media into the interactive device and respond to output produced by the system.

### BACKGROUND

The present invention relates to an interactive learning system, and in particular, an interactive learning system which utilizes content on cards associated with content on compact discs.

### SUMMARY

An interactive learning system includes an interactive medium, content medium and an interactive device for interfacing between the two. The interactive medium has a first content and a first identifier for identifying the interactive medium and first content. The content medium has a second content and a second identifier for identifying the content medium and the second content. The interactive device reads and compares the first and second identifiers and accesses a portion of the second content related to the first identifier. The interactive learning system also has an input module for receiving information from a user and an output module for communicating information to a user.

### BRIEF DESCRIPTION OF THE DRAWINGS

FIG. 1 is a perspective view of an interactive learning system with a first interactive media, in accordance with one embodiment;

FIG. 2 is a perspective view of an interactive learning system with a second interactive media, in accordance with one embodiment;

FIGS. 3A, 3B, and 3C are perspective views of content medium and interactive medium being used with an interactive learning system, in accordance with one embodiment;

FIG. 4 is a side view of an interactive learning system, in accordance with one embodiment;

FIG. 5 is a top view of an interactive learning system, in accordance with one embodiment;

FIG. 6 is a front view of an interactive learning system, in accordance with one embodiment;

FIG. 7 is a front view of a first content medium for use with an interactive learning system, in accordance with one embodiment;

FIG. 8 is a front view of a second content medium for use with an interactive learning system, in accordance with one embodiment;

FIG. 9 is a functional block diagram of an interactive learning system, in accordance with one embodiment;

FIG. 10 is a detailed functional block diagram of an interactive learning system, in accordance with one embodiment;

FIG. 11 is a functional block diagram of an interactive learning system, in accordance with one embodiment; and

FIGS. 12-17 are flowchart illustrations of various aspects of an interactive learning system, in accordance with one embodiment.

It should be appreciated that for simplicity and clarity of illustration, elements shown in the Figures have not necessarily been drawn to scale. For example, the dimensions of some elements may be exaggerated relative to each other for clarity. Further, where considered appropriate, reference numerals have been repeated among the Figures to indicate corresponding elements.

### DETAILED DESCRIPTION

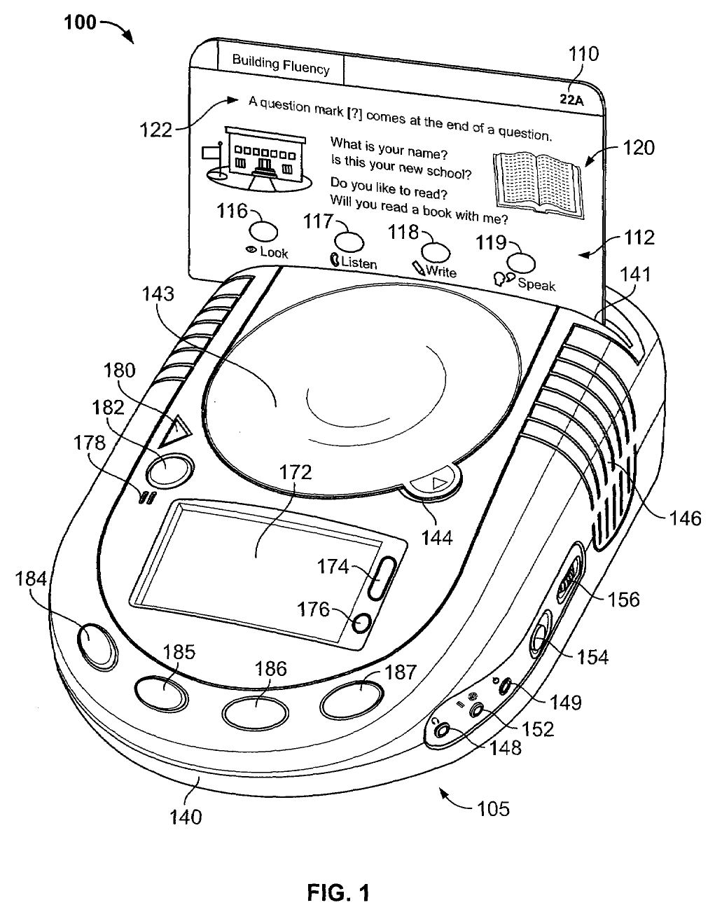

Shown in FIGS. 1, 9 and 10 is an interactive learning system 100 providing activities that combine the use of printed material or other visual materials and audio prompts and user responses. The interactive learning system 100 includes removable media 102 and an interactive device 101 for interacting with the removable media 102. The removable media includes at least one interactive medium 103 and at least one content medium 104. Interactive medium 103 is any medium which can be held, read, or interacted with by a user, such as a card 110. The content medium 104 is any medium which stores information which can later be accessed by a reader designed to access that medium.

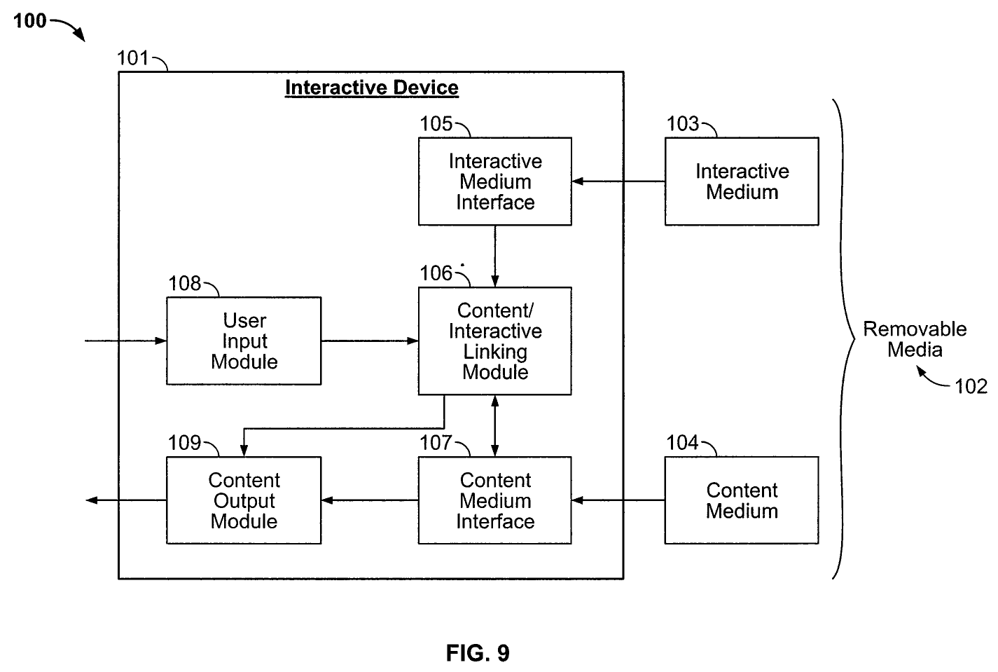

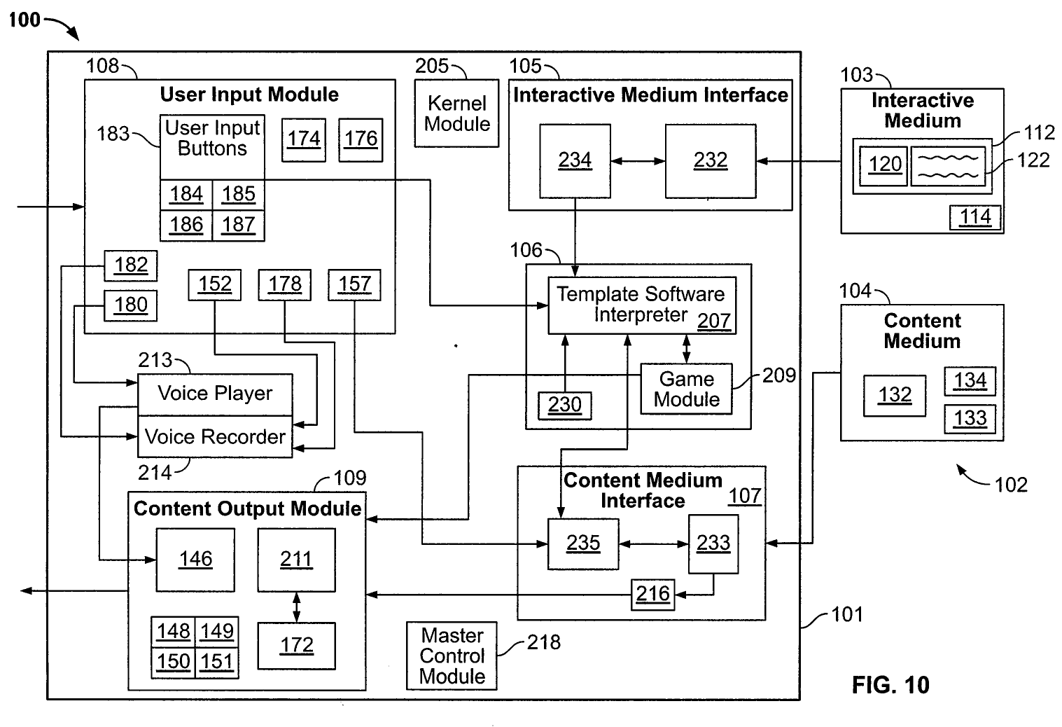

As shown in FIGS. 9 and 10, the interactive medium 103 includes first content 112 and first identifier 114. The first content 112 is any type of information on the interactive medium 103 which conveys information to the user which the user can interact with, including pictures 120, text 122, raised marks, indented marks, and computer readable devices such as magnetic strips or Radio Frequency Identification (RFID) tags. Preferably, the first content 112 is viewed by a user and provides questions, answers and/or visual clues relating to an activity defined by a template 230.

The first identifier 114 is any type of marker on the interactive medium 103 which identifies a specific interactive medium 103, and includes such things as bar codes 115, numbers, letters, symbols, indentations, raised portions, and embedded computer readable devices such as RFID tags or magnetic strips. Preferably, the first identifier 114 comprises a combination of characters that is unique to a specific interactive medium 103.

The interactive medium 103 also includes a template identifier 137 which identifies a template stored in the interactive device 101 to be used with the specific interactive medium 103 that the template identifier is located on. The template identifier 137 can be a portion of the first identifier 114, or the template identifier 137 can be separate from the first identifier 114. Preferably, each interactive medium 103 includes only one template identifier 137 which identifies only a single template. However, different interactive medium 103 may be linked to different templates to form a set of interactive mediums 103.

Content medium 104 includes any type of analog medium and any type of digitally encoded medium, such as: magnetic media including hard disks, floppy disks, and tapes; solid state media including RAM, ROM, and flash memory; optical media including a compact disc (CD) 130, a digital versatile disc (DVD), a Blu-Ray disc, and a HD-DVD disc. Content medium 104 may include a combination of analog and digital medium. Content medium 104 includes second content 132 and a second identifier 133. The second content 132 is any type of information on the content medium 104 which can be read by an analog or digital reader and which can later be output for the user to read, see, or listen to. The second content 132 can include any analog or digitally encoded information, such as binary data, analog sound recordings, digital sound recordings, video recordings, digital picture files, audio files, movie files, text files, data files, activity files, tactile files which may contain information used to create Braille or provide a tactile feedback to the user, and other such information.

The second identifier 133 is any type of marker on the content medium 104 which identifies a specific content medium 104, and includes such things as bar codes, numbers, letters, symbols, indentations, raised portions, embedded computer readable devices such as RFID tags or magnetic strips, and any analog or digitally encoded information which is embedded or stored in the content medium 104, such as binary data, analog sound recordings, digital sound recordings, video recordings, digital picture files, text files, data files, and other such information. Preferably, the second identifier 133 comprises a combination of characters that is unique to a specific content medium 104.

The content medium 104 also includes index information 134 embedded on the content medium 104. The index information 134 includes an index of the set of second content 132 files stored on the content medium 104. The content medium 104 must be properly formatted so that the second content 132 is stored as index information 134 and an index is created. The index is used by a template software interpreter 207 to link a template 230 to the second content 132.

The first content 112 on the interactive medium 103 is linked to the second content 132 on the content medium 104 using the interactive device 101. The interactive device 101 includes an interactive medium interface 105 for reading the first identifier 114 from the interactive medium 103 and a content medium interface 107 for accessing second content 132 on the contact medium 104 and outputting the second content 132 directly through a content output module 109.

The interactive medium interface 105 includes a first reader 232 for reading the first identifier 114 and a first reader driver 234 for controlling the first reader 232. The first reader 232 includes any device which can access and read the first identifier 114, such as, for example, optical scanners such as a bar code scanner 142, a magnetic strip reader, an RFID reader, and other such devices. The first reader driver 234 includes software and hardware for controlling the first reader 232, and performs actions such as activating the first reader 232, stopping the first reader 232, and other such actions. The interactive medium interface 105 communicates with the content/interactive linking module 106 upon reading the first identifier 114 and relays the information contained within the first identifier 114 to the content/interactive linking module 106.

The contact medium interface 107 is essentially any type of reader designed to access second content 132 on the type of content medium 104 being used. For example, if the content medium 104 is a compact disc 130, then the contact medium interface 107 would include a compact disc reader 145. The content medium interface 107 includes a second reader 233 for accessing second content 132 and reading the second identifier 133. The content medium interface 107 also includes a second reader driver 235 for controlling the second reader 233. The second reader 233 includes any device which can access and read the second content 132 or the second identifier 133, such as, for example, optical scanners such as a bar code scanner 142, a magnetic strip reader, an RFID reader, a magnetic media reader including a hard disk, a floppy disk drive, and a tape drive; solid state media reader including RAM, ROM, and a flash memory reader; an optical media reader including a compact disc player, a digital versatile disc (DVD) player, a Blu-Ray disc player, and a HD-DVD disc player, and other such devices. The second reader driver 235 includes software and hardware for controlling the second reader 233, and performs actions such as activating the second reader 233, stopping the second reader 233, and other such actions. The content medium interface 107 communicates with the content/interactive linking module 106 upon reading the second identifier 133 or the second content 132 and relays the information contained within the second identifier 133 or the second content 132 to the content/interactive linking module 106. The content medium interface 107 also directly communicates with the content output module 109, and is able to second information contained within the second content 132 directly to the content output module 109 to be output to the user. For example, audio information contained within the second content 132 can be directly sent to the content output module 109 to be output as sound through a speaker to the user.

The interactive device 101 includes a content/interactive linking module 106 connected with a user input module 108 and a content output module 109. The content/interactive linking module 106 receives information contained in the first identifier 114 from the interactive medium interface 105 once the first identifier 114 is read by the interactive medium interface 105. The content/interactive linking module 106 also receives information contained in the second identifier 133 from the content medium interface 107, once the content medium 104 is accessed by the content medium interface 107. Upon receiving information from the first identifier 114 and the second identifier 133, the content/interactive linking module 106 then compares the first identifier 114 to the second identifier 133 and determines if the two identifiers 114, 133 match.

If there is no match between the first identifier 114 and the second identifier 133, the content/interactive linking module 106 sends an error code to the content output module 109 to indicate to the user that the interactive medium 103 and the content medium 104 do not match. If the interactive medium 103 and the content medium 104 do match, then the content/interactive linking module 106 sends a first command to the content medium interface 107 to access and read information from the content medium 104, such as second content 132 or index information 134.

Additionally, upon receiving the index information 134, the content/interactive linking module 106 then compares the index information 134 with templates 230 stored in the content/interactive linking module 106 and sends a command to the content medium interface 107 to access and output specific second content 132 through the content output module 109. Upon receiving information output from the content output module 109, a user may input information through the user input module 108 to the content/interactive linking module 106. Upon receiving the information through the user input module 108, the content/interactive linking module 106 then sends a command to the content medium interface 107 to access and output specific second content 132 through the content output module 109. To conduct these operations, the content/interactive linking module 106 includes hardware, such as a processor, and software.

In one embodiment, the content/interactive linking module 106 includes a template software interpreter 207 that uses the information from the first identifier 114 to identify a template 230 that defines the way in which the second content 132 on the compact disc 130 is accessed and presented to the user. The content/interactive linking module 106 may include many templates 230, each associated with a template identifier. A listing of sample templates is included in APPENDIX A, although other templates are possible. A particular template 230 may be used in connection with a specific interactive medium 103 and a specific content medium 104, if the first identifier 114 stored on the interactive medium 103 includes a template identifier 137 which identifies that particular template 230.

The templates 230 define the order, manner and format in which the second content 132 on the content medium 104 is presented to the user. A specific template 230 can set into motion a sequence of interactions and audio/visual responses between a user and the interactive learning system 100. For example, a template 230 may first cause the interactive device 101 to access a first portion of second content 132 upon reading the first identifier 114 and the second identifier 133, and then output the first portion of second content 132 though the content output module 109 to the user. The user may then press a button 183 in response to receiving the first portion of second content 132, and then the template 230 will in return cause the interactive device 101 to access a second portion of second content 132 in response to the user's pressing of button 183. The interaction between the user and the interactive device 101, and the information sent to the user by the interactive device 101 in response to the user's pressing of buttons 183, is controlled by the template 230.

In general, the templates 230 are organized in a tree structure. Each branch of the tree is chosen based on input from the user. For example, if the user enters an incorrect answer in response to a question posed by the interactive device 101, the template 230 may access specific second content 132 on the content medium 104 that tells the user to try again. So that the template 230 may locate the required or specific second content 132 on the content medium 104, the content medium 104 is formatted so that the second content 132 is stored as indexed information 134 and an index is created. The template 230 uses this index to locate specific second content 132.

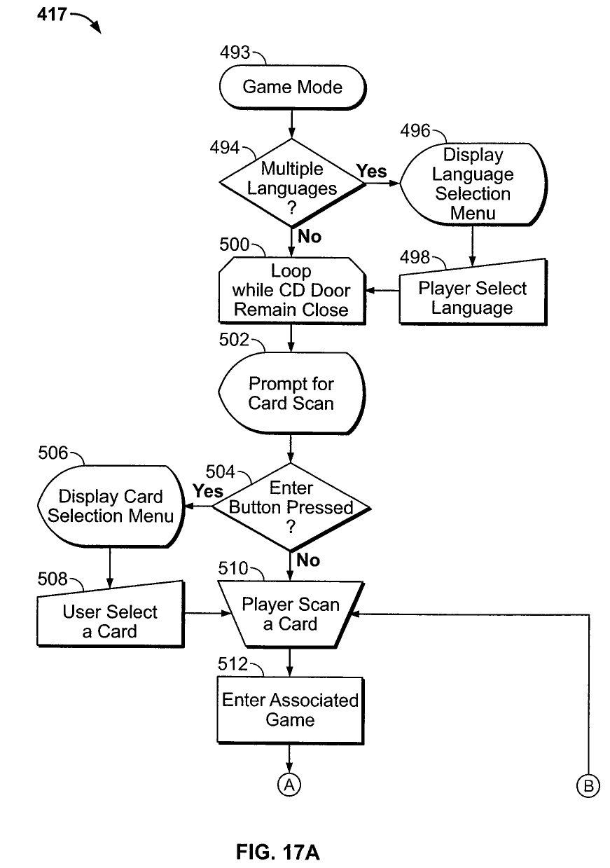

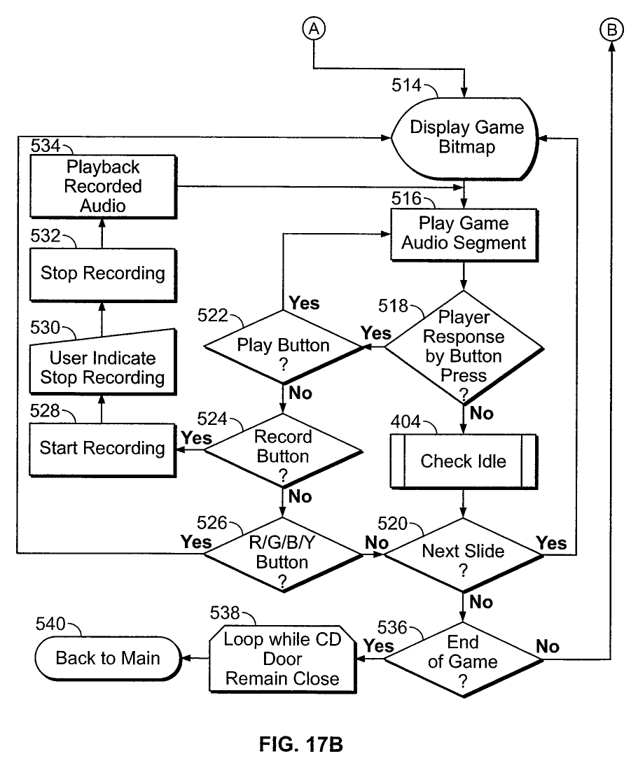

The content/interactive linking module 106 also includes a game module 209. The game module 209 controls the interaction between the user, the interactive device 101, and specifically, the user and the first content 112 on the interactive medium 103 and the second content 132 on the content medium 104. The operation of the game module 209 is discussed in more detail below with the discussion of the game mode operation 417, shown in FIG. 17.

The user input module 108 receives information from a user and relays that information to the content/interactive linking module 106. The user input module 108 includes any device which can be used to receive information input from a user and relay that information to the content/interactive linking module. The user input module 108 includes devices such as a microphone 178, a microphone jack 152, a voice recorder 214, buttons 184, 185, 186, 187, up/down navigation buttons 174, an enter button 176, a play button 180, a record button 182, second reader control buttons 157, a keyboard, a mouse, a touchpad, a trackball, a joystick, and other such user/input devices, and an input port for receiving user input or other types of information from an external device.

The content output module 109 is any device which can be used to output second content 132 accessed on the content medium 104. The content output module 109 is connected with the content medium interface 107 and outputs sensory information to a user through visual, audio, tactile, or other types of medium. The content output module 109 includes such things as a display driver 211, a display 172 for outputting visual information, a speaker 146 for outputting audible sounds, headphone jacks 148, 149, 150, 151 for outputting audible sounds, a Braille output device for outputting tactile feedback, and a tactile feedback device for outputting tactile feedback. The content output module 109 can also include a digital output port for communicating audio content in digital form to external audio content display (through wired or wireless communication) with a D/A converter and audio content display such as computer. The content output module 109 can also include any type of wireless or wired communications data port for outputting information stored within the interactive device 101, the interactive medium 103, and the content medium 104, and other such things.

The interactive device 101 also includes a master control module 218 and a kernel programming module 205. The master control module 218 controls the first reader 232, the second reader 233, and the display 172 and receives input from the user input module 108. The master control module 218 issues commands to the first reader 232 and receives first content 112 from the interactive medium 103. The master control module 218 also issues commands to the second reader 233 and receives second content 132 from the content medium 104.

The kernel programming module 205 is the central module of the operating system for the interactive device 101. The kernel programming module 205 loads into main memory before any other module and remains in main memory. The kernel programming module 205 is responsible for memory management, process and task management, and disk management. The kernel programming module 205 will be programmed for system use. The kernel programming module 205 can also be used as an operating system to link up to system software. The kernel programming module 205 includes all software device drivers and controls memory management, process and task management, and disk management for the interactive device 101.

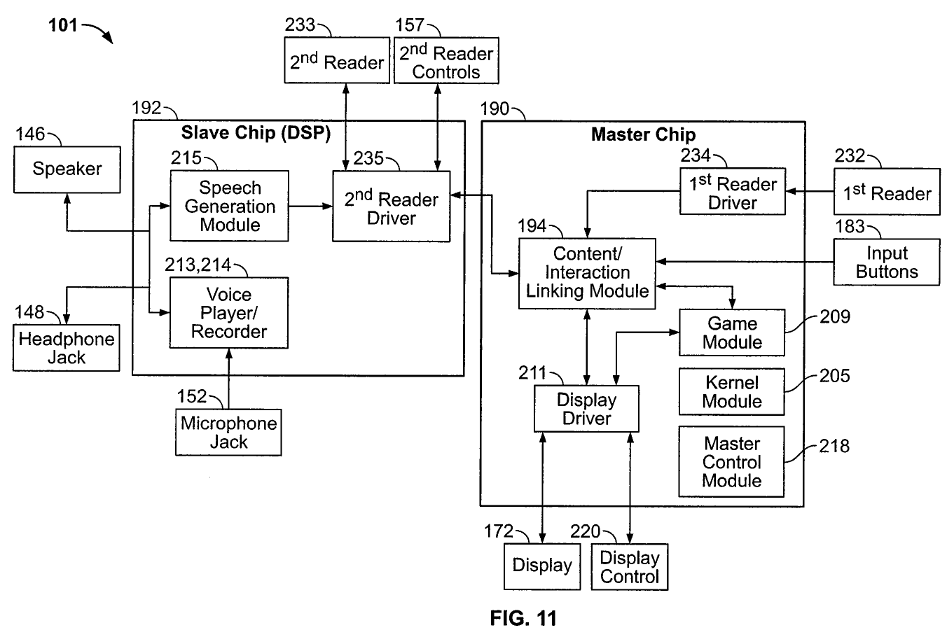

In one embodiment, the interactive device 101 includes a master chip 190 and a slave chip 192, as shown in FIG. 11. The master chip 190 is preferably a central processing unit which contains and runs certain components of the interactive device 101. The master chip 190 includes the content/interaction linking module 106, the first reader driver 234, the game module 209, a kernel module 205, a master control module 218, and the display driver 211. The content interaction linking module 194 is in communication with the display driver 211 and can send and receive information to and from the display driver 211. The content interaction linking module 194 is in communication with the game module 209 and can second or receive information to and from the game module 209. The contact interaction linking module 194 is also in communication with input buttons 183, which are outside of the master chip 190, and can send information input from the user to the contact interaction linking module 194. The contact interaction linking module 194 also receives information from the first reader driver 234. The first reader driver 234 is in communication with a first reader 232 which sends information, such as first content 112, to the first reader driver 234 for processing. Kernel module 205 and master control module 218 also reside in the master chip 190. Display driver 211 sends and receives information to and from the content interaction linking module 194. The display driver 211 sends and receives information to and from the display 172 and also sends and receives information to and from the display control 220, which serves as the control logic for the display 172.

The slave chip 192 is in communication with the master chip 190. The slave chip 192 includes a voice player 213 and a voice recorder 214, a speech generation module 216, and a second reader driver 235. The second reader driver 235 sends and receives information to and from the content interaction linking module 194. The voice player 213 and recorder 214 is in communication with the speech generation module 216 which also sends information to the second reader driver 235. Speech generation module 216 is in communication with a speaker 146 and a headphone jack 148, both of which are outside of the slave chip 192. Preferably, the slave chip 192 is a digital signal processor. A microphone jack 152 is also in communication with the slave chip 192 and the voice recorder 214. The second reader 233 is in communication with the second reader driver 235 and the second reader control buttons 157 are also in communication with the second reader driver 235.

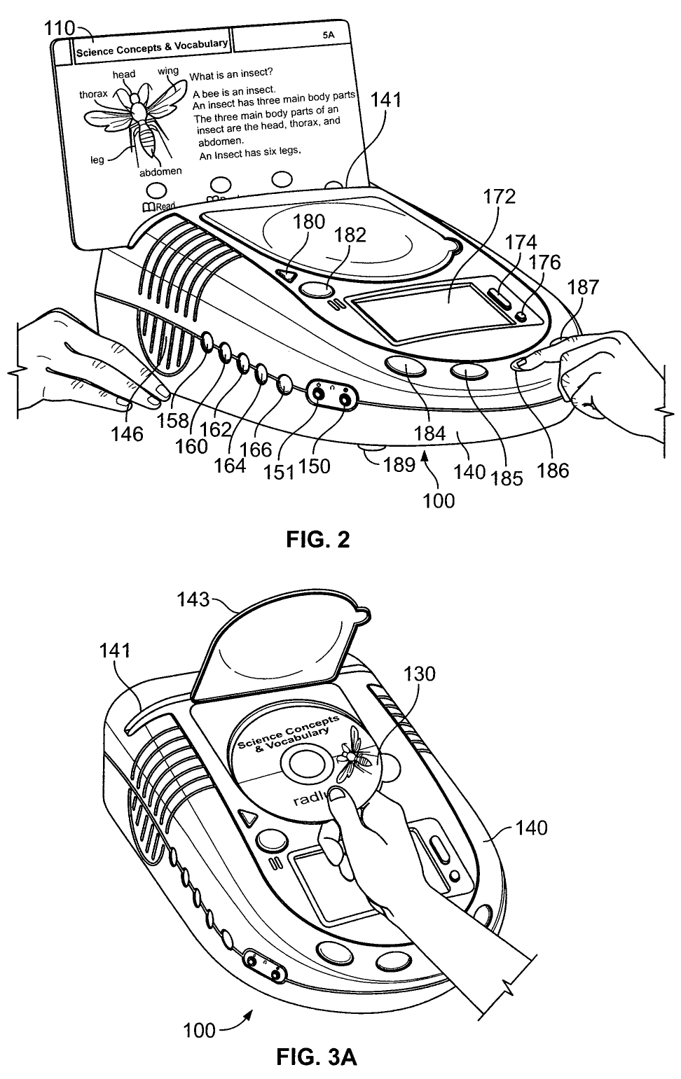

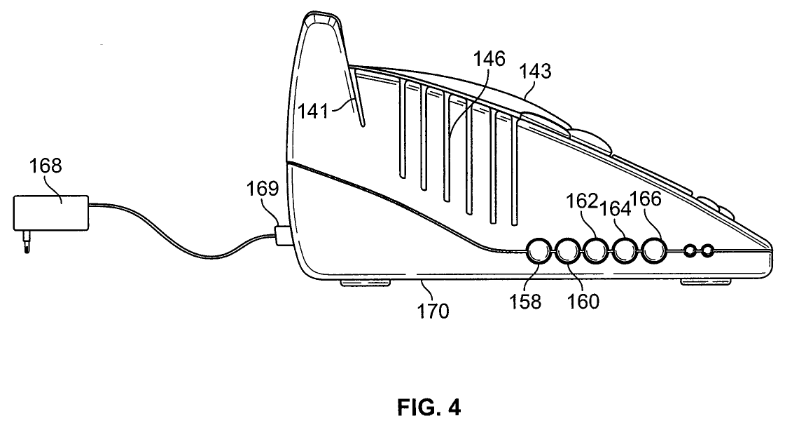

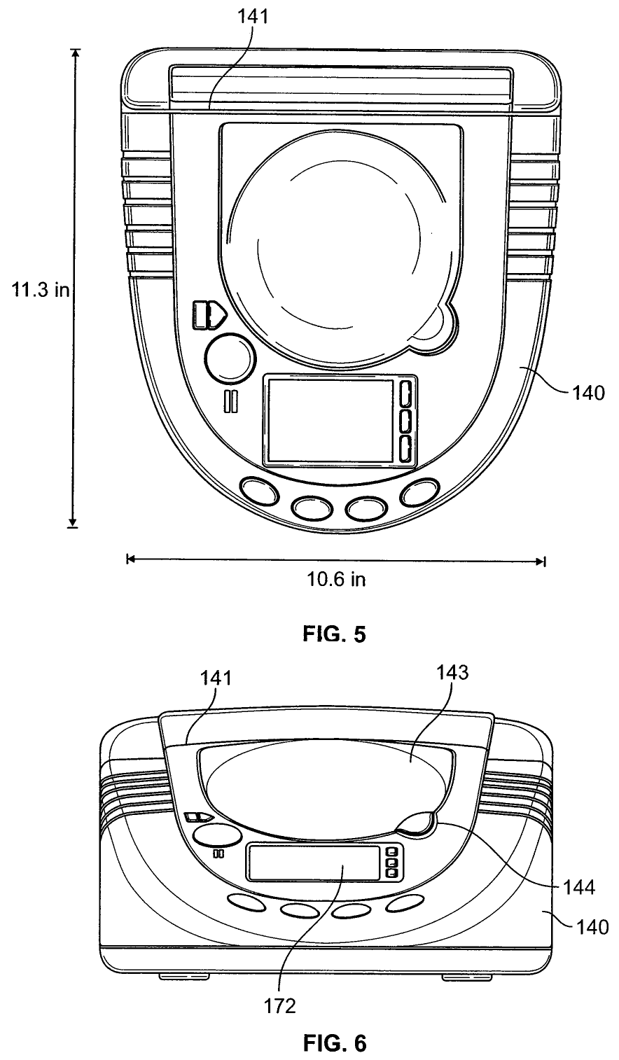

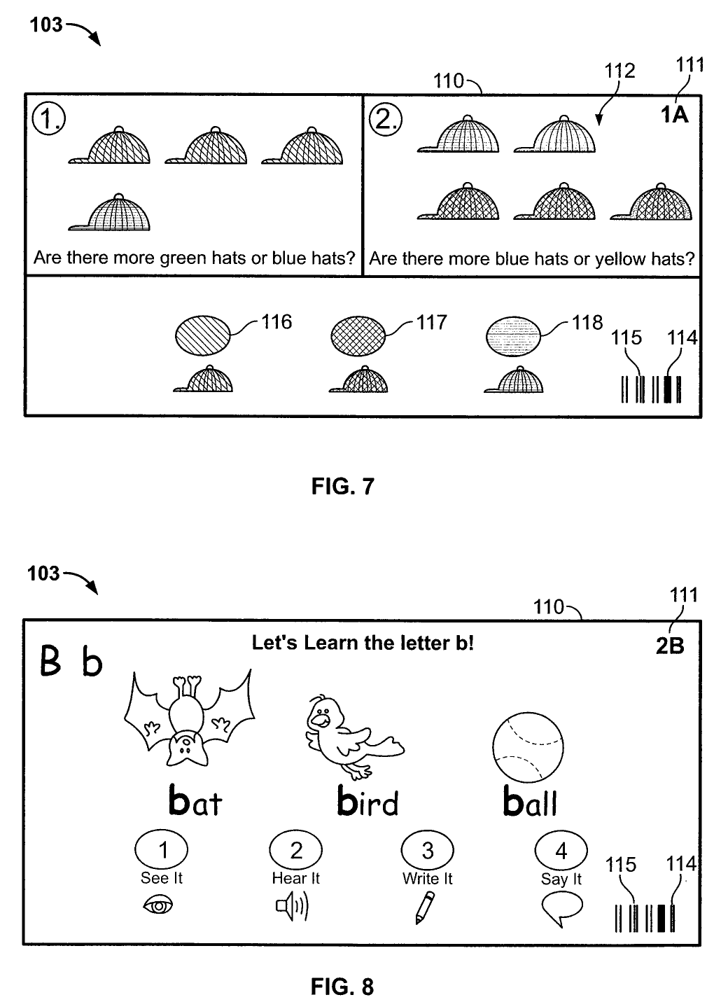

In one embodiment, the interactive device 101 includes interactive medium 103 which is a card 110 with first content 112, and content medium 104 which is a compact disc 130 with second content 132, as illustrated in FIGS. 1-8. The first content 112 on the card 110 is in printed form and may include colored symbols 116, 117, 118, 119, pictures 120, text 122, and a first identifier 113 which are all designed to interact with the second content 132 stored on the compact disc 130, which is in audio and/or visual form. The colored symbols 116, 117, 118, 119 preferably match and correspond to colored symbol buttons 184, 185, 186, 187. The user is able to interact with the interactive medium 103 by pressing the colored symbol button 184, 185, 186, 187 which corresponds to the colored symbols 116, 117, 118, 119. The colored symbols 116, 117, 118, 119 may include commands for the interactive device 101 or the user to conduct, such as “Look,” “Listen,” “Write,” and “Speak,” as shown in FIGS. 1 and 8. The colored symbols 116, 117, 118, 119 may also just relate to an object or picture which can be used during the interactive learning process, as shown in FIG. 7. The first content 112 can contain and present any number of learning exercises to a user for interaction with the user, wherein all of the exercises contain colored symbols 116, 117, 118, 119 which correspond to colored symbol buttons 184, 185, 186, 187, allowing for interaction between the user and the interactive device 101.

The first content 112 on the card 110 also includes a first identifier 114. The first identifier 114 can be encoded in an machine-readable form, and includes such things as bar codes, numbers, letters, symbols, indentations, raised portions, and embedded computer readable devices such as RFID tags or magnetic strips. In this embodiment, the first identifier 114 on the card is in the form of a bar code 115, as shown in FIGS. 7 and 8. The first identifier 114 includes various type of information, such as interactive medium first identifier 114 which identifies a particular interactive medium 103 or card 110, template first identifier 114 which identifies a particular template 230 to be used with the particular interactive medium 103, and content medium identification information which identifies a content medium 104 to be used with the particular interactive medium 103.

The compact disc 130 includes second content 132. The second content 132 may include a number of questions to be presented orally, and the card 110 may include printed materials, such as pictures 120 and text 122, representing potential answers to questions. In addition, the second content 132 may include correct answers, related questions and suggestions for other activities to be presented orally and/or visually, all which are stored on the compact disc 130. Preferably, the second content 132 is stored in a standard audio format on the compact disc 130, wherein additional information is encoded in the audio format. Preferably, the second content 132 is in an audio compact disc (CD) format, specifically a Red Book Audio CD format. The second content 132 is encoded digitally on the compact disc 130 as two-channel stereo sound. Preferably, two discrete monaural audio tracks are recorded as one two-channel stereo track. By recording two monaural audio tracks as one two-channel stereo track, space is saved on the compact disc 130 so that more second content 132 can be stored on the compact disc 130. Preferably, at least one of the discrete monaural audio tracks includes non-audio information embedded within the track. Non-audio information could include any type of information which is stored and does not contain audio information, including textual information such as words and graphical information such as pictures or illustrations.

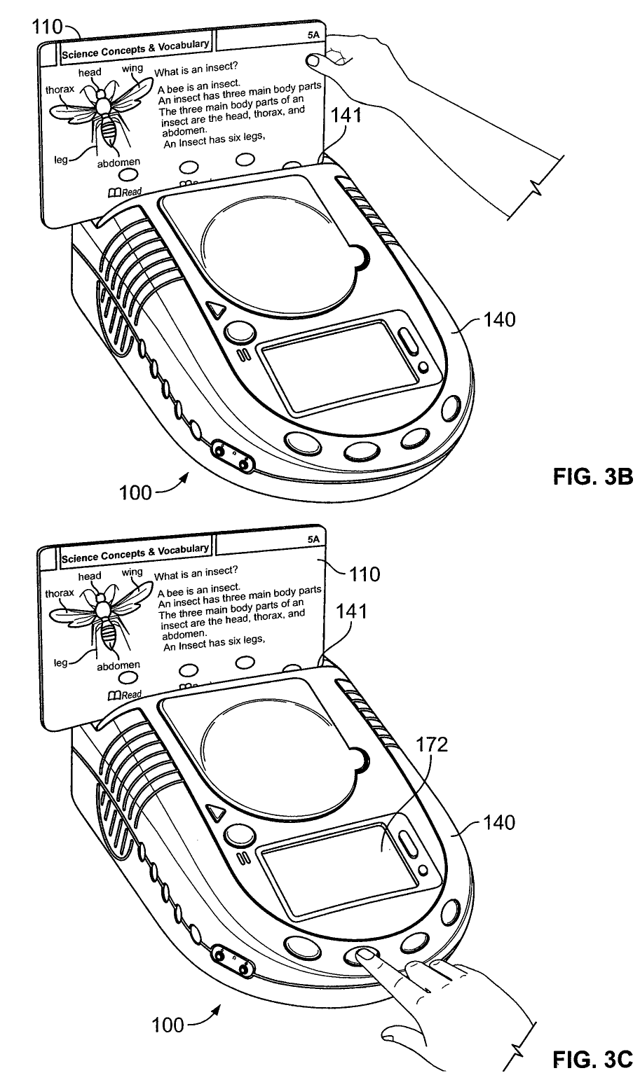

The interactive device 101 includes a compact disc reader 145 which operates as the second reader 233 and a barcode scanner 142 which operates as the first reader 232. Compact disc reader 145 includes a compact disc cover or door 143 which opens and closes through use of a door release 144, to allow a user to insert a compact disc 130 into the compact disc reader 145, as shown in FIGS. 1 and 3A. The barcode scanner 142 reads the barcode information 115 found on the card 110 and includes a card scanning slot 141 formed in the interactive device 101 for inserting and removing cards 110, as shown in FIGS. 1, 3B, and 3C.

The interactive device 101 also includes a user input module 108 which includes user input devices such as a microphone 178, a microphone jack 152, a voice recorder 214, colored symbol buttons 184, 185, 186, 187, up/down navigation buttons 174, an enter button 176, a play button 180, a record button 182, a volume dial 156, a power switch 154, and second reader control buttons 157, as shown in FIGS. 1, 2 and 4-6. The record button 182, when pressed, allows a user to record no more than a predetermined amount of audio, such as no more than two minutes of audio, via the microphone 178 or a microphone connected to the microphone jack 152. Preferably the voice recorder 214 records a user's voice in order to facilitate a timed language fluency test.

Recorded audio can then be played back by the user by pressing the play button 180, allowing the user or another user to listen to the recorded audio. Second reader control buttons 157 include a stop button 158, a play button 160, a pause button 162, a back button 164, and a forward button 166.

The interactive device 101 also includes a content output module 109 which includes such things as a display 172, a speaker 146, and headphone jacks 148, 149, 150, 151 all for output content from the interactive device 101 to the user. The display 172 can be any type of device used to display pictures or text, such as, an LCD screen, a cathode ray tube, a DLP display, a plasma display, or other such display. In one embodiment, the display 172 is a three inch by two inch active dot matrix liquid crystal display (LCD) screen which is able to display at least four lines of text.

The interactive device 101 receives power in one of many ways, such as through batteries, or through a connection with AC power lines. In one embodiment, the interactive device 101 includes a battery compartment 170 for holding batteries used to power to the interactive device 101, and includes an AC power adapter 169 connected to a power adapter plug 168 located on the interactive device 101. The AC power adapter 169 converts AC power to DC power to power the interactive device 101.

As an example of how the interactive device 101 is used, a user first provides power to the interactive device 101 by either plugging the AC power adapter 169 to the power adapter plug 168 on one end and to a wall outlet on another end, or the user inserts batteries into the battery compartment 170, if not already done. Upon providing power to the interactive device 101, the user then switches the power on for the interactive device 101 by moving power switch 154 to an ON position. Upon being turned on, the interactive device 101 will then determine whether or not a content medium 104 has been inserted into the second reader 233, i.e. whether or not a compact disc 130 has been inserted into the compact disc reader 145. If a content medium 104 has not been inserted into the second reader 233, the interactive device 101 will notify the user of this, by displaying a message on the display 172. Upon insertion of a content medium 104 into the second reader 233, the interactive device 101 will access second content 132 stored on the content medium 104, first prompting the user to select a language, i.e. English or Spanish, if various language options are available. The interactive device 101 will then prompt the user to insert an interactive medium 103, such as a card 110, into the interactive device 101 so that the first reader 232, such as the card reader 140, can read and access the first identifier 114 on the interactive medium 103. The interactive device 101 then determines whether the interactive medium 103 matches the content medium 104, and if so, then begins a game mode operation and begins to interact with the user. Upon completion of the game mode operation, or interaction with the user, the user can then choose another interactive medium 103 or content medium 104 to interact with, or the user can choose to end his or her interaction with the interactive device 101. Upon choosing to end his or her interaction with the interactive device 101, the user can power off the interactive device by moving the power switch 154 to an OFF position.

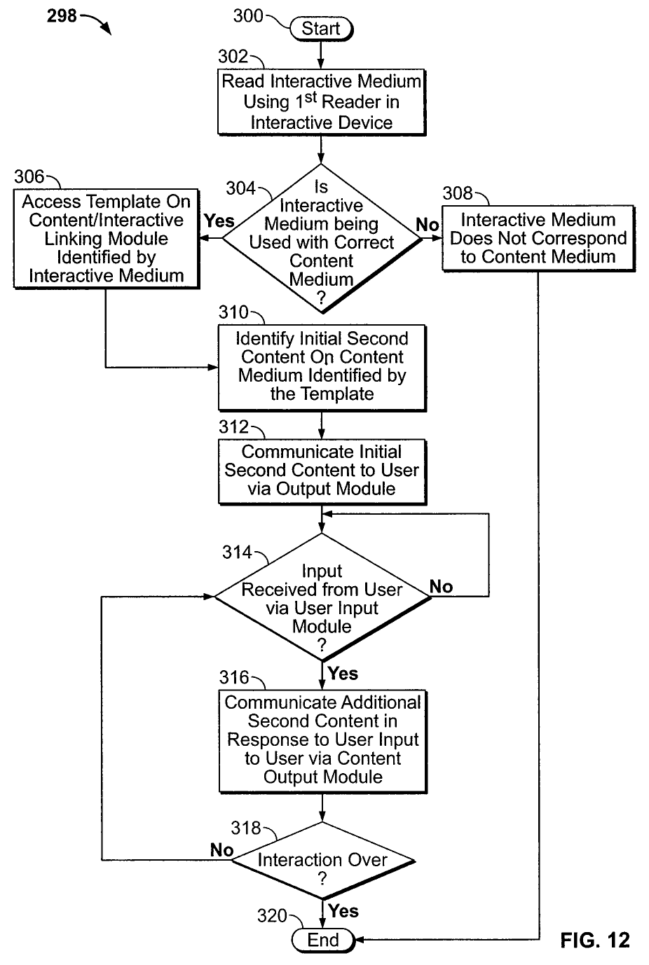

FIGS. 12-17 are flowchart illustrations of various aspects of the invention. Each block of the flowchart illustrations in FIGS. 12-17, and combinations of blocks in the flowchart illustrations in FIGS. 12-17, can be implemented by computer program instructions. These computer program instructions may be loaded onto a computer or other programmable data processing apparatus, such that the instructions which execute on the computer or other programmable data processing apparatus to implement the functions specified in the flowchart block or blocks. These computer program instructions may also be stored in a storage device that can direct a computer or other programmable data processing apparatus to function in a particular manner, such that the instructions stored in the storage device implement the functions specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions which execute on the computer or other programmable apparatus provide steps for implementing the functions specified in the flowchart block or blocks.

Accordingly, blocks of the flowchart illustrations in FIGS. 12-17 support combinations of means for performing the specified functions, combinations of steps for performing the specified functions and program instruction means for performing the specified functions. It will also be understood that each block of the flowchart illustrations in FIGS. 12-17, and combinations of blocks in the flowchart illustrations in FIGS. 12-17, can be implemented by special purpose hardware-based computer systems which perform the specified functions or steps, or combinations of special purpose hardware and computer instructions.

As seen in FIG. 12, a start operation is initiated in Block 300 which begins an interactive learning process 298. Upon initiating the start operation in Block 300, the interactive learning process 298 then moves to Block 302 and begins to read the interactive medium 103 using the first reader 232 of the interactive device 101. Upon reading the interactive medium 103, more specifically the first content 112 on the interactive medium 103, the interactive learning process 298 then moves to Block 304 and determines whether the interactive medium 103 is being used with the correct content medium 104. In order to determine this, the interactive learning process 298 compares a first identifier 113 from the first content 112 with a second identifier 133 from the second content 132. If the interactive device 101 determines that the first identifier 113 does not match the second identifier 133, then the interactive learning process 298 moves to Block 308. At Block 308 the interactive medium is determined not to correspond with a contact medium 104. Upon making this determination, the interactive learning process 298 ends at Block 320.

If the first identifier 113 matches the second identifier 133, then the interactive learning device 101 determines that the interactive medium 103 is being used with the correct content medium 104 and the interactive learning process 298 then moves to Block 306. At Block 306 the interactive learning process 298 determines whether to access a template 230 on the content/interactive linking module 106 which is identified by the interactive medium 103 and in particular by the first identifier 113. Upon accessing the template 230 on the content/interactive linking module 106 identified by the interactive medium 103, the interactive learning process 298 then moves to Block 310 and identifies first portion of second content 132 on the content medium 104 which is identified by the template 230. The interactive learning process 298 then moves to Block 312 and communicates the first portion of second content 132 to the user via content output module 109.

The interactive learning process 298 then determines if an input is received from a user via the user input module 108. If no input has been received, the interactive learning process 298 then just goes back to Block 314 and waits until an input is received from a user via the user input module 108. If input has been received from the user via the user input module 108, then the interactive learning process 298 moves to Block 316 and communicates a second portion of second content 132 in response to user input to user via the content output module 109. The interactive learning process 298 then moves to Block 318 and determines whether the interaction between the user and the interactive device 101 has ended or not.

At Block 318, the game module 209 receives and processes user input into three parts, using an index file associated with the first identifier 114, and determines: (1) what audible second content 132, such as an audio WAV file, that should be output through speaker 146 or headphone jacks 148, 149, 150, 151 by the interactive device 101; (2) what visually encoded second content 132 that should be displayed on the display 172, if any; and (3) what is the response of the interactive device 101 after determining the previous two questions. The third item is known as the trigger code. The trigger code determines if the interactive device 101 sits idle at the end of the game mode operation 417, if no trigger code is present, or if the interactive device 101 initiates another sequence, including termination of the current game mode operation 417 and returning to a “Scan a Card” prompt and requesting a new game sequence to be chosen by the user.

If it has been determined that the interaction between the user and the interactive device 101 has not ended, the interactive learning process 298 then moves to Block 314 and determines whether input has been received from the user via the user input module 108. However, if it has been determined that the interaction between the user and the interactive device has ended, then the interactive learning process 298 moves to Block 320 and ends the interactive learning process 298.

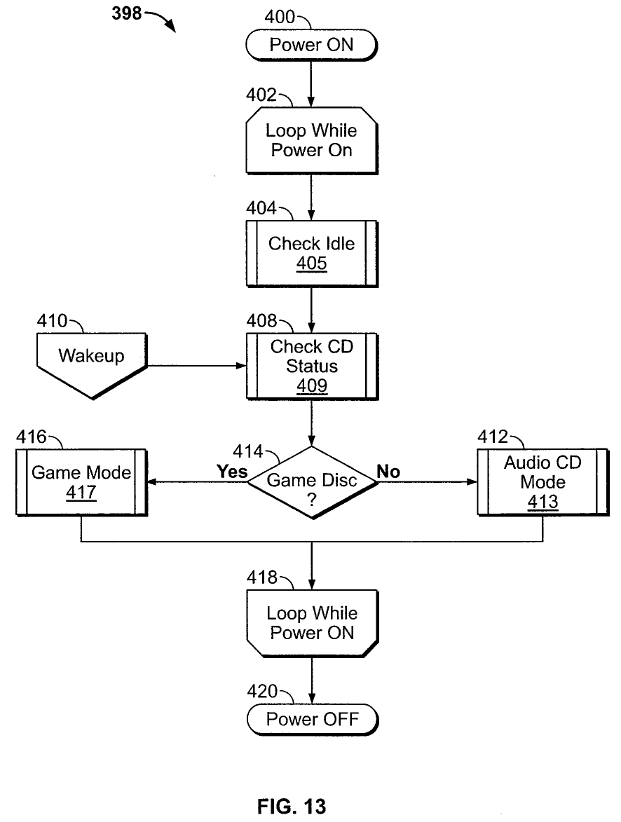

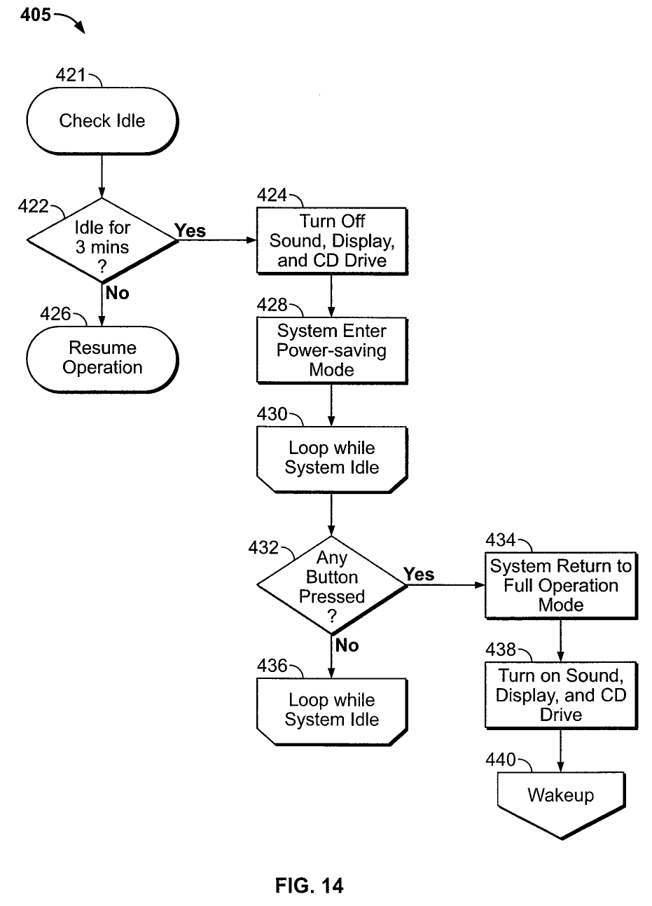

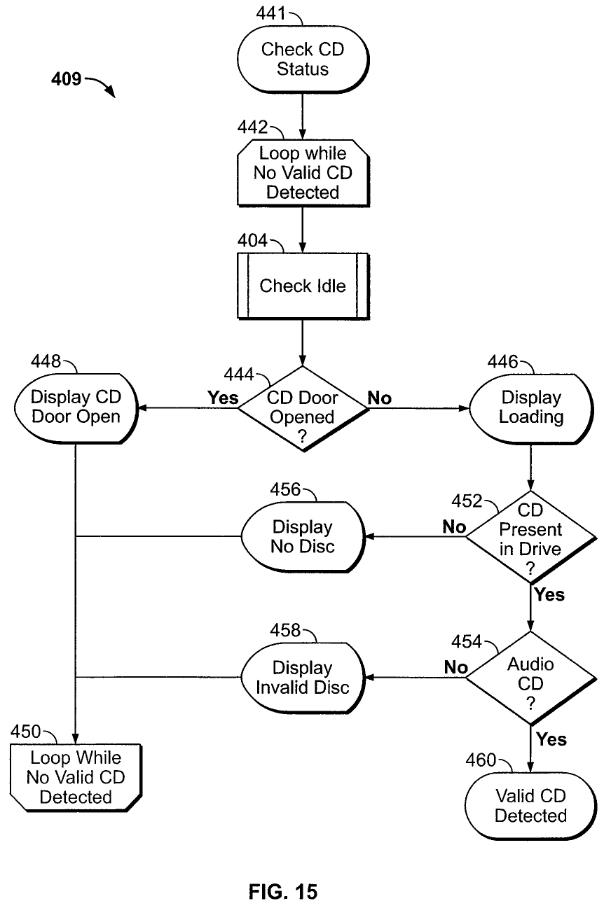

As seen in FIG. 13, a power on operation 398 is initiated in Block 400. The power on operation 398 is initiated in the master control module 218 once the user depresses the power switch 154 of the interactive device 101. The power on operation 398 begins by displaying an opening screen on the display 172. Once this occurs, the power on operation 398 initiates a continuous loop for as long as power is supplied to the interactive device 101, as shown in Block 402. The continuous loop begins at Block 402 and ends at Block 418 at which point in time the continuous loop then moves back to Block 402. Upon initiating the loop while power on operation in Block 402, the power on operation 398 then moves to Block 404 and initiates a check idle operation 405, as illustrated in FIG. 14. Upon conducting the check idle operation 405 in Block 404, the power on operation 398 then moves to Block 408 and initiates a check CD status operation 409, as illustrated in FIG. 15. Both the check idle operation 405 and the check CD status operation 409 are described subsequently. The check CD status operation 409 can also be initiated upon a wakeup operation, as shown in Block 410. The wakeup operation occurs upon receiving input from a user when the interactive device 101 is in a lower power, or power-saving mode. The power-saving mode is the result of the interactive device 101 not being used by a user for a given period of time, and essentially causes the interactive device 101 to conserve energy and be placed in a lower power state. Upon receiving input from a user when the interactive device is in the power-saving mode, the power on operation 398 initiates the wakeup operation of Block 410 and moves to Block 408 to initiate the check CD status operation 409.

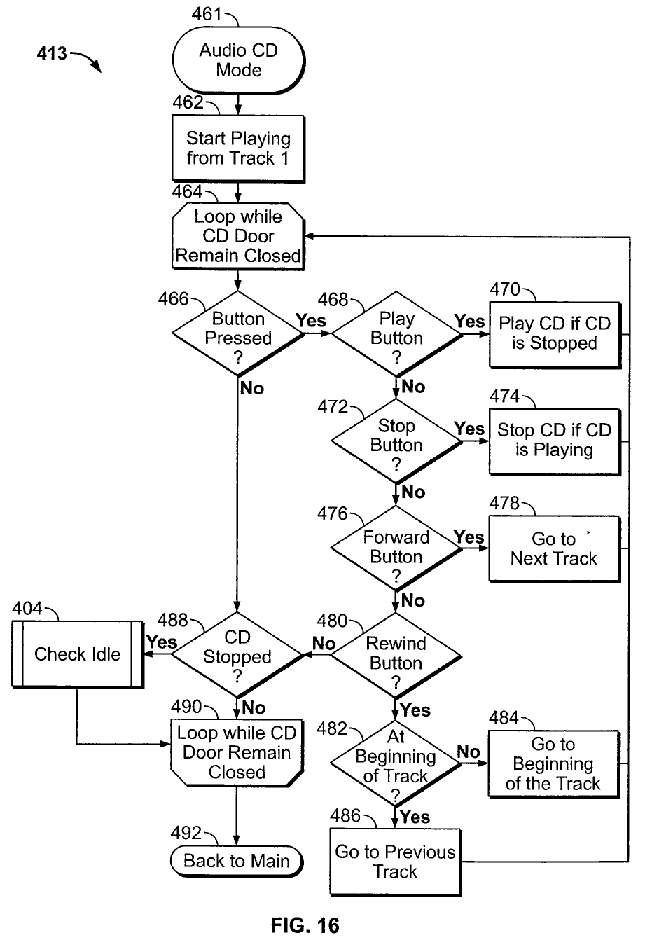

Upon conducting the check CD status operation 409, the power on operation 398 then moves to Block 414, as shown in FIG. 13, and determines whether or not the content medium 104 within the interactive device 101 is a game disk or not. Game disks are essentially medium which are recognized as content medium 104 having second content 132 stored on them for use with the interactive device 1 1. If it is determined that the content medium 104 is a game disk, then the power on operation 398 moves to Block 416 and initiates a game mode operation 417, as illustrated in FIG. 17. If it is determined that the content medium 104 is not a game disc, then the power on operation 398 moves to Block 412 and initiates an audio CD mode operation 413, as illustrated in FIG. 16. Upon conducting either the game mode operation 417 shown in Block 416 or the audio CD mode operation 413 shown in Block 412, the power on operation 398 then moves to Block 418, at which point in time the continuous loop then moves back to Block 402. If power is cut off from the interactive device 101, the power on operation 398 then moves to Block 420 and powers off the interactive device 101. Typically, power is cut off from the interactive device 101 once a user presses the power switch 154, shown in FIG. 1, a second time.

As seen in FIG. 14, a check idle operation 405 is initiated in Block 421. The check idle operation 405 is designed to determine whether or not the interactive device 101 is in an idle mode or not, that is, whether or not the interactive device 101 is being used by a user. If it is determined that the interactive device is not being used by a user, and a set or predetermined period of time has passed, the check idle operation 405 will cause the interactive device 101 to enter a power-saving mode. Upon initiating the check idle operation 405 in Block 421, the check idle operation 405 moves to Block 422 and determines whether or not the interactive device 101 has been idle for a set period of time, such as 3 minutes, or not. If the interactive device 101 has been idle for a predetermined period of time, then the check idle operation 405 moves to Block 424, and the sound from speaker 146, the display 172, and the second reader 233 are turned off. Upon turning off the sound from speaker 146, the display 172, and the second reader 233, the check idle operation 405 moves to Block 428, and the interactive device 101 enters a power-saving mode. The power-saving mode is a low power state in which the interactive device 101 uses significantly less power, such as at least 10% less power, than it would if in a full operation mode or when first powered on. Upon entering the power saving mode in Block 428, the check idle operation 405 then moves to Block 430 and initiates a loop while system idle operation, which is a continuous loop between Block 430 and Block 436 for as long as the interactive device 101 is in an idle state or power-saving mode. Upon initiating the loop while system idle operation in Block 430, the operation then moves to Block 432 and checks whether or not any button, such as input buttons 183, second reader control buttons 157, or other such buttons, on the interactive learning device 101 has been pressed by a user. If a button has been pressed, then the check idle operating moves to Block 434 and the interactive device 101 returns to a full operation mode. Upon returning to the full operation mode, the interactive device 101 then moves to Block 438 and turns on sound to the speaker 146, the display 172, and the second reader 233. Upon turning on the sound, the display 172, and the second reader 233, the check idle operation then moves to Block 440 and returns the interactive device to a wakeup state or full operation mode. However, if no button has been pressed in Block 432, the check idle operation 405 then moves to Block 436 and continues the loop while system idle operation.

As seen in FIG. 15, a check CD status operation 409 is initiated in Block 441. The check CD status operation 409 is initiated in order to determine the status of the second reader 233. Upon initiation, the check CD status operation 409 then moves to Block 442 and enters a continuous loop so long as no valid CD, or content medium 104, is detected. The continuous loop begins at Block 442 and ends at Block 450 at which point in time the continuous loop then moves back to Block 442. Upon initiating the loop while no valid CD is detected operation in Block 442, the check CD status operation 409 moves to Block 421 and initiates a check idle operation 405, as illustrated in FIG. 14. Upon initiating the check idle operation 405, the check CD status operation 409 then moves to Block 444 and checks whether or not a door of the second reader 233 is opened or not. If a door is not opened, the check CD status operation 409 then moves to Block 446 and displays a “loading” term on the display 172, indicating that the reader 233 is loading or reading second content 132 from the content medium 104.

If the CD door is opened, the check CD status operation 409 moves to Block 448 and displays a “CD Door Open” term on the display 172 and then moves to Block 450 at which point in time the continuous loop then moves back to Block 442. Upon displaying the “loading” term on the display 172 in Block 446, the check CD status operation 409 then moves to Block 452 and determines whether a CD, or content medium 104, is present in the second reader 233. Upon determining that a CD, or content medium 104, is not present in the reader 233, the check CD status operation 409 moves to Block 456 and displays a “no disk” message on the display 172, and then moves to Block 450 at which point in time the continuous loop then moves back to Block 442. If a CD, or content medium 104, is present in the reader 233, the check CD status operation 409 then moves to Block 454 and determines whether or not the content medium 104 contains second content 132, such as an “audio CD.” If the content medium 104 contains second content 132, the check CD status operation 409 moves to Block 460 and then determines that a valid CD or content medium 104 has been detected. If there is no second content 132, or audio CD information, in the content medium 104, then the check CD status operation 409 then moves to Block 458 and display an “invalid disk” message on the display 172, and then moves to Block 450 at which point in time the continuous loop then moves back to Block 442.

As seen in FIG. 16, an audio CD mode operation 413 is initiated in Block 461. The audio CD mode operation 413 essentially begins to access second content 132 from the content medium 104 and interact with that second content based upon input from a user. Upon initiation, the audio CD mode operation 413 moves to Block 462 and begins playing second content 132 from a first track on the audio CD, or content medium 104, as illustrated in Block 462. Upon playing the first track from the content medium 104, the audio CD mode operation 413 then moves to Block 464 and begins a continuous loop so long as the door to the second reader 233 remains closed. The continuous loop begins at Block 464 and ends at Block 490 at which point in time the continuous loop then moves back to Block 464. During the continuous loop begun in Block 464, the audio CD mode operation 413 moves to Block 466 and determines whether or not a button, such as second reader control buttons 157, is pressed. If a button is pressed, the audio CD mode operation 413 moves to Block 468 and asks whether or not the button is a “play” button. If the button pressed is a “play” button, then the audio CD mode operation 413 moves to Block 470 and plays the second content 132 from the content medium 104 if the reader 233 is stopped. Upon playing the second content 132, the audio CD mode operation 413 then moves back to the beginning of the continuous loop while the CD door remains closed operation in Block 464. If the “play” button is not pressed, then the audio CD mode operation 413 moves to Block 472 to determine whether a “stop” button was pressed. If a “stop” button was pressed then the audio CD mode operation 413 moves to Block 474 and stops playing or accessing the content medium 104 if the content medium 104 is being accessed or played. Upon stopping the playing or accessing of the content medium 104, the audio CD mode operation 413 then moves back to the beginning of the continuous loop while the CD door remains closed operation in Block 464.

If a “stop” button has not been pressed, then the audio CD mode operation 413 moves to Block 476 and determines whether a “forward” button has been pressed. If a “forward” button has been pressed, then the audio CD mode operation 413 moves to Block 478 and goes to the next track of content on the content medium 104. Upon going to the next track of content, the audio CD mode operation 413 then moves back to the beginning of the continuous loop while the CD door remains closed operation in Block 464. If the “forward” button is not pressed, then the audio CD mode operation 413 moves to Block 480 and determines whether a “rewind” button is pressed. If a “rewind” button is pressed, then the audio CD mode operation 413 moves to Block 482 and determines whether or not the reader 233 is accessing second content 132 at the beginning of a track. If the reader 233 is not accessing second content 132 at the beginning of a track, then the audio CD mode operation 413 moves to Block 484 and accesses second content 132 at the beginning of a track on the content medium 104. Upon accessing second content 132 at the beginning of a track on the content medium 104, the audio CD mode operation 413 then moves back to the beginning of the continuous loop while the CD door remains closed operation in Block 464.

If the reader 233 is accessing second content 132 at the beginning of a track on the content medium 104, then the audio CD mode operation 413 moves to Block 486 and goes to the previous track to access second content 132 at the beginning of the previous track. Upon accessing second content 132 at the beginning of a previous track on the content medium 104, as shown in Block 486, the audio CD mode operation 413 then moves back to the beginning of the continuous loop while the CD door remains closed operation in Block 464.

If it is determined that a button has not been pressed in Block 466, the audio CD mode then moves to Block 488 and determines whether or not the reader 233 has been stopped. If the reader 233 has been stopped then the audio CD mode operation 413 moves to Block 421 and initiates a check idle operation 405, as illustrated in FIG. 14. Upon initiating the check idle operation 405, the audio CD mode operation 413 moves to Block 490 and continues the loop while the CD door remains closed operation initiated in Block 464. If it has been determined that the reader 233 has not been stopped in Block 488, the audio CD mode operation 413 moves to Block 490 and continues the loop while the CD door remains closed operation initiated in Block 464. If instructed to do so by a user, the audio CD mode operation 413 moves to Block 492 and goes back to a main menu.

As seen in FIG. 17, a game mode operation 417 is initiated in Block 493. The game mode operation 417 is run by the game module 209, shown in FIG. 10, and controls how a user interacts with the interactive device 101, and specifically, how the user interacts with the first content 112 on the interactive medium 103 and the second content 132 on the content medium 104. Upon initiating the game mode operation 417 in Block 493, the game mode operation 417 then moves to Block 494 and determines whether or not multiple languages, such as English and Spanish, are supported by the content medium 104. If multiple languages are supported, the game mode operation 417 then moves to Block 496 and displays a language selection menu. The language selection menu allows the user to select among various languages to be displayed and orally generated by the interactive device 101. The multiple languages are stored in multiple directories, from which audio files for each respective language are pulled. For example, on a given set of content medium 104 and interactive medium 103, a first directory could store English language files, a second directory could store Spanish language files, and a third directory could store German language files. One of the templates 230 would then control how these language files are stored and accessed.

Upon displaying the language selection menu, the game mode operation 417 then moves to Block 498 and waits for a user to select a particular language. Upon selection of a particular language by the user, the game mode operation 417 then moves to Block 500.

If multiple languages are not supported by the contact medium 104, then the game mode operation 417 moves to Block 500 and initiates a continuous loop so long as the door on the reader 233 remains closed. The continuous loop begins at Block 500 and ends at Block 538 at which point in time the continuous loop then moves back to Block 500. Upon initiating the continuous loop in Block 500, the game mode operation 417 then moves to Block 502 and prompts the user to insert the interactive medium 103 into the interactive medium interface 105, and in particular, into the first reader 232, so that the interactive medium interface 105 can read the first content 112 on the interactive medium 103.

Upon prompting the user in Block 502, the game module then waits to see if the enter button 176 has been pressed or not, as illustrated in Block 504. If the enter button 176 is pressed, the game mode operation 417 then moves to Block 506 wherein the game mode operation 417 displays a card selection menu and prompts the user to select a particular interactive medium 103, such as a card 110. Each interactive medium 103 bears a unique user identifiable mark 111 from which the user can identify that particular interactive medium 103. The user identifiable mark 111 may be a series of numbers and letters, for example. Preferably, the card selection menu lists a set of interactive medium 103 and identifies each one of them by its user identifiable mark 111. Upon being presented with the card selection menu, the game mode operation 417 moves to Block 508, wherein a user then selects a particular or specific interactive medium 103 from the selection menu presented in Block 506. Upon selecting a specific interactive medium 103, the game mode operation 417 then moves to Block 510 and waits for the user to scan a specific, selected interactive medium 103.

If the enter button is not pressed in Block 504, the game mode operation 417 moves to Block 510 and waits for the user to select and scan a specific interactive medium 103 by taking the interactive medium 103 and inserting it into the first reader 232. Upon the user scanning a specific interactive medium 103, as shown in Block 510, the game mode operation 417 then moves to Block 512 and enters a specific game based upon a template selected by the template software interpreter 207. Upon entering the associated game in Block 512, the game mode operation 417 then moves to Block 514 and displays a game bitmap. The game bitmap can include an object, an alphanumeric letter, a symbol, or other bitmap which is displayed on the display 172 as a result of game mode operation 417 entering the associated game. Upon displaying the game bitmap in Block 514, the game mode operation 417 then moves to Block 516 and plays an audio segment of second content 132 from the content medium 104 as instructed by the template. Upon playing a specific second content 132 from the contact medium 104, the game mode operation 417 waits for a response from the user upon listening to or receiving the second content 132, as shown in Block 518. The response from the user can include things such as pressing a button, such as an input button 183. If the game mode operation 417 determines the user has pressed a button, or sent some sort of response to the interactive device, the game mode operation 417 then moves from Block 518 to Block 522 and determines what type of response was received by the user. In Block 522, the game mode operation 417 determines whether or not a “play” button 180 was pressed. If a “play” button 180 was pressed, then the game mode operation 417 moves to Block 516 and plays a specific or selected second content 132, which may or may not be the same second content 132 which was previously selected.

If the “play” button 180 was not pressed, then the game mode operation 417 determines whether a “record” button 182 was pressed, as shown in Block 524. If the game mode operation 417 determines that a “record” button 182 has been pressed, then the game mode operation 417 moves from Block 524 to Block 528 and causes the voice recorder 214 to initiate recording the user's voice, as shown in Block 528. Upon initiating the recording of the user's voice in Block 528, the game mode operation 417 then moves to Block 530 upon receiving indication from the user to stop their recording, such as upon receiving a second signal from the record button 182 indicating that the record button has been pressed a second time. The game mode operation 417 moves to Block 532 and stops recording the user upon receiving indication from the user that he wishes to stop the recording. Upon stopping recording the user, the game mode operation 417 then moves to Block 534 and plays back the recorded audio, through a device in the output module 109, such as the speaker 146. Once the recorded audio has been played back, the game mode operation 417 returns to Block 516 and plays an audio segment of second content 132 from the content medium 104 as instructed by the template.

If the “record” button has not been pressed in Block 524, then the game mode operation 417 moves to Block 526 and determines whether or not one of the input buttons 183 has been pressed. If the game mode operation 417 determines that an input button 183 has been pressed, then the game mode operation 417 returns to Block 514 and displays a game bitmap depending on what button had been pressed by the user. If no button had been pressed by the user then the game mode operation 417 then moves from Block 526 to Block 520 and determines whether or not to go to a next slide.

If the game mode operation 417 determines to go to the next slide, then the game mode operation 417 returns to Block 514 and displays a game bitmap. However, if the game mode operation 417 determines not to go to the next slide, then the game operation moves to Block 536 and determines whether or not it is at the end of the game. If the game mode operation 417 determines that it is at the end of a game, the game mode operation 417 then moves to Block 538 and continues the loop begun in Block 500, as long as door to the second reader 233 remains closed. If the user presses a main menu button, then the game mode operation 417 moves from Block 538 to Block 540 and goes back to a main menu.

In Block 518, if it is determined that the player has not responded, such as by pressing any buttons, the game mode operation 417 moves to Block 421 and begins a check idle operation 405, as illustrated in FIG. 14. Upon completion of the check idle operation 405, the game mode operation 417 then moves to Block 520 and determines whether or not to go to the next slide.

As will be appreciated by those of skill in this art, the preceding examples are provided, not to limit or define the scope of the present invention, but to illustrate the nature of the present invention and possible uses for the teachings of the present invention. These examples may be modified in many different ways while still obtaining the benefits of the teachings of the present invention. While the invention has been described and illustrated, this description is by way of example only. Additional advantages will occur readily to those skilled in the art, who may make numerous changes without departing from the true spirit and scope of the invention. Therefore, the invention is not limited to the specific details, representative machines, and illustrated examples in this description. Accordingly, the scope of this invention is to be limited only as necessitated by the accompanying claims. Various features and advantages of the invention are set forth in the following claims.

What is claimed is:

1. An interactive learning system, comprising:
interactive medium having a first content and a first identifier for identifying the interactive medium and the first content;
content medium having a second content and a second identifier for identifying the content medium and the second content; and
an interactive device for interfacing with the interactive medium and the content medium, wherein the interactive device includes
an interactive medium interface for reading the first identifier,
a content medium interface for reading the second identifier and the second content,
a content/interactive linking module for comparing the first identifier with the second identifier and for accessing at least a specific portion of the second content related to the first identifier, and
an output module for communicating information to a user.

2. The interactive learning system according to claim 1, further comprising an input module for receiving information from a user, wherein the input and output modules are connected with the content/interactive linking module.

3. The interactive learning system according to claim 1, wherein the interactive medium interface includes a first reader for reading the first identifier and the content medium interface includes a second reader for reading the second content.

4. The interactive learning system according to claim 3, wherein the first reader is an optical scanner and the second reader is an optical media reader.

5. The interactive learning system according to claim 1, wherein the input module includes a button and the first content includes at least one symbol which corresponds to the button.

6. The interactive learning system according to claim 1, wherein the output module outputs visual information and audible sounds upon receiving information from the content/interactive linking module.

7. The interactive learning system according to claim 1, further comprising a voice recorder and a voice player.

8. A method for learning, comprising:
reading a first identifier from an interactive medium having first content;
reading a second identifier from a content medium having second content;
determining whether the interactive medium is to be used with the content medium;
accessing a first portion of second content as a result of reading the first identifier; and
outputting the first portion of second content through an output module.

9. The method for learning of claim 8, further comprising accessing a specific template as a result of reading the first identifier, wherein the specific template identifies a first portion of second content to be accessed.

10. The method for learning of claim 9, wherein the specific template sets into motion a sequence of interactions and audio/visual responses between a user and an interactive learning system.

11. The method for learning of claim 9, wherein upon the determining of whether the interactive medium is to be used with the content medium, a user can provide input through an input module, and a second portion of second content can be output in response to the input from the user.

12. The method of claim 8, wherein the determining of whether the interactive medium is to be used with the content medium comprises comparing the first identifier to the second identifier.

13. The method of claim 8, further comprising receiving input from an input module and accessing a second portion of second content as a result receiving the input.

14. The method of claim 13, further comprising outputting a second portion of second content through an output module in response to receiving input from the input module

15. The method of claim 8, wherein the reading of the first identifier comprises scanning a bar code using a bar code scanner.

16. The method of claim 8, wherein the accessing of the first portion of second content includes reading audio information from a compact disc.

17. The method of claim 8, wherein the outputting of the first portion of second content includes outputting audio information as sound through a speaker.

18. An interactive device for interfacing with interactive medium and content medium, wherein the interactive device comprises:
a first reader for reading a first identifier;
a second reader for reading a second identifier and second content;
a content/interactive linking module for comparing the first identifier with the second identifier and for accessing a specific portion of the second content as a result of reading the first identifier;
an input module for receiving information from a user; and
an output module for relaying information to a user,
wherein the input and output modules are connected with the content/interactive linking module.

19. The interactive device according to claim 18, wherein the first reader is an optical scanner and the second reader is an optical media reader.

20. The interactive learning system according to claim 18, wherein the input module includes a button and the first content includes at least one symbol which corresponds to the button.

21. The interactive learning system according to claim 18, wherein the output module outputs visual information and audible sounds upon receiving information from the content/interactive linking module.

22. The interactive learning system according to claim 18, further comprising a voice recorder and a voice player.

23. The interactive learning system according to claim 22, wherein the voice recorder records a voice in order to facilitate a timed test.

24. A content medium for storing information, the content medium comprising a compact disc having two discrete channels of audio information stored as a single stereo channel, wherein at least one of the discrete channels includes non-audio information embedded within the channel.
